(19) United States
(12) Patent Application Publication
(10) Pub. No.: US 2007/0259224 A1
(43) Pub. Date: Nov. 8, 2007

(54) SHUT-DOWN PROCEDURE FOR FUEL CELL

(76) Inventors: CHUN-CHIN TUNG, Chu Pei (TW); Yung-Lieh Chien, Chu Pei (TW)

Correspondence Address: G. LINK CO., LTD, 3550 BELL ROAD, MINOOKA, IL, 60447, US

(21) Appl. No.: 11/740,935

(22) Filed: Apr. 27, 2007

(30) Foreign Application Priority Data
May 4, 2006 (TW) 095115842

(51) Int. Cl. H01M 8/04

(52) U.S. Cl. 429/13; 429/24

(57) ABSTRACT

The invention discloses a shut-down procedure for the fuel cell, which includes a portion of electricity generation, a control unit, an inner load end, an outer load end, a fan, a pump and means of judging the temperature difference between the inside and the outside of the fuel cell, and works with the fan and the pump working continuously under the control of the control unit, the shut-down procedure starting under the judgment of the control unit and comprising steps of: starting under the selection of the control unit, together with stopping the work of the pump under the selection of the control unit; judging whether the temperature difference between the inside and the outside of the fuel cell is lower than a specified value or not, by means of the means of judging the temperature difference between the inside and the outside of the fuel cell; and stopping the work of the fan under the selection of the control unit if the temperature difference between the inside and the outside of the fuel cell is lower than the specified value. The shut-down procedure can thus be performed for the fuel cell in a safe condition.

### FIELD OF THE INVENTION

The present invention relates to a shut-down procedure for fuel cells, the shut-down procedure being provided so that judgments may be performed, by means of a control unit, on whether the conditions for the shut-down state of a fuel cell are attained or not, wherein the means of a control unit monitors the temperature difference between the fuel cell and the working environment and the concentration of the fuel solution residue in the fuel cell.

### BACKGROUND OF THE INVENTION

Conventional fuel cells generally include cell cores utilizing hydrogen-rich fuels and oxygen-rich fuels to perform electrochemical reactions and generate electricity. Take the direct methanol fuel cell (DMFC) for an example, which belongs to the type of proton exchange membrane fuel cell (PEMFC); the DMFC uses liquid methanol directly for fuel supply and there is no need with reformers for reforming methanol, gasoline, natural gas, etc. from which hydrogen may be extracted for electricity generation. The principle of action lies in that the DMFC contains anode and cathode electrodes with a permeable membrane constructed there between. The principal part of the electrolyte forms as an ion exchange membrane. The surface of the membrane is coated with a catalyst to increase the reaction rate. The methanol solution passes the anode and enters the fuel cell while oxygen passes the cathode and enters the fuel cell, so that the hydrogen atoms of methanol crack into protons and electrons under the catalysis wherein the protons pass down to the other side of the membrane to form water with oxygen and the electrons reach the cathode via an external circuit so that an electrical loop is formed.

In the application of such fuel cells, once the electrochemical reaction occurs, it can continue until the fuel solution supplied to the proton exchange membrane reacts completely, no matter whether there are load terminals or not. Nevertheless, in case that there are no load terminals, continuous electrochemical change on the proton exchange membrane can cause the mist produced in the reaction to condense on the sets of membrane electrodes within the cell core so that short-circuit damage, among the sets of membrane electrodes, would result from the mist. Conventionally, addition of water is adopted for diluting the concentration of the fuel solution in the proton exchange membrane to a level below a specified value so as to stop or slow down the electrochemical reaction in the sets of membrane electrodes. In this way, however, not only the input of pure water consumes additional electricity but also the following drainage of mist requires some fans working or else short-circuit damage among the sets of membrane electrodes would occur when the mist condenses on the sets of membrane electrodes.

In view of the shortcomings in the conventional method and the apparatus to realize the method, the inventors have endeavored to invent a control unit that can monitor the fuel solution residue in the proton exchange membrane, wherein a shut-down procedure may be performed, according to whether there is any load or not or what the condition set by the control unit is for starting a shut-down instruction, so as to control the concentration of the fuel solution in the anode of the fuel cell, or alternatively controlling the temperature difference between the fuel cell and the environment so as to avoid condensation of mist.

### SUMMARY OF THE INVENTION

The primary objective of the invention is to provide a shut-down procedure for fuel cells, the shut-down procedure being performed by means of a control unit monitoring the work of a fan of the fuel cell so that, when a shut-down instruction being performed, the fan works continuously till the temperature difference between the fuel cell and the environment is small sufficiently so as to avoid electrical short circuit resulting from condensation of mist in the portion of electricity generation of the fuel cell.

Another objective of the invention is to provide a shut-down procedure for fuel cells, the shut-down procedure being performed by means of a control unit monitoring the concentration of the fuel solution in the proton exchange membrane so that, when a shut-down instruction being performed, the pump that supplies the fuel solution to the proton exchange membrane from the fuel supply tank stops working and the fan works continuously to consumes the residual electricity that the proton exchange membrane can generate from the fuel solution residue therein.

Yet another objective of the invention is to provide a shut-down procedure for fuel cells, wherein a secondary cell is used internally for maintaining the control unit, the pump and the fan working with the electricity in need when the fuel cell stop generating electricity.

To achieve the above-mentioned objectives, the invention discloses a shut-down procedure for a fuel cell, which includes a portion of electricity generation, a control unit, an inner load terminal, an outer load terminal, a fan, a pump and means of judging temperature difference for judging whether the temperature difference between the inside and the outside of the fuel cell is lower than a specified value of temperature difference or not, and works with the fan and the pump working continuously under the control of the control unit, the shut-down procedure starting under the judgment of the control unit and comprising steps of: starting under the selection of the control unit, together with stopping the work of the pump under the selection of the control unit; judging whether the temperature difference between the inside and the outside of the fuel cell is lower than a specified value of temperature difference or not, by the means of judging temperature difference; and stopping the work of the fan under the selection of the control unit if the temperature difference between the inside and the outside of the fuel cell is lower than the specified value.

Furthermore, the fuel cell includes means of judging concentration for judging whether the concentration of the fuel solution residue in the portion of electricity generation is lower than a specified value of concentration or not, the step of starting under the selection of the control unit is followed by steps of: judging whether the concentration of the fuel solution residue in the portion of electricity generation is lower than the specified value of concentration or not, by the means of judging concentration; and stopping the work of the fan under the selection of the control unit if the concentration of the fuel solution residue in the portion of electricity generation is lower than the specified value of concentration while the temperature difference between the inside and the outside of the fuel cell is lower than the specified value of temperature difference.

Thus, the shut-down procedure can be performed for the fuel cell in a safe condition.

A detailed description is given in the following embodiments with reference to the accompanying drawings, for those skilled in the art to understand the objectives, features and functions of the present invention.

### BRIEF DESCRIPTION OF THE DRAWINGS

FIG. 1 is a diagram of element relation for the shut-down procedure of the present invention for a fuel cell.

FIG. 2 is a flow chart of the shut-down procedure of the present invention for a fuel cell.

FIG. 3 is another element relation diagram for the shut-down procedure of the present invention for a fuel cell.

FIG. 4 is a flow chart of the shut-down procedure of the present invention for a fuel cell based on the embodiment in FIG. 3.

### DETAILED DESCRIPTION OF THE INVENTION

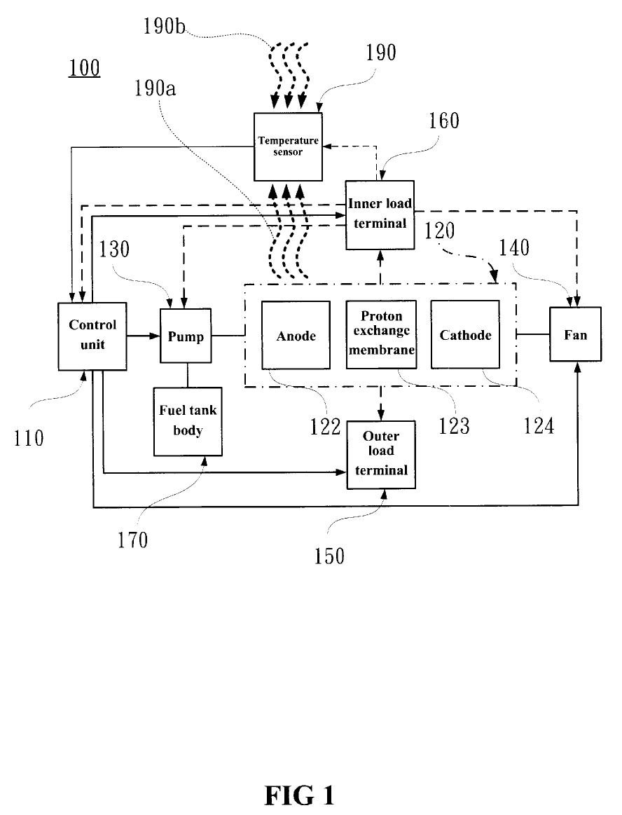

Refer to FIG. 1, which illustrates a diagram of element relation for the shut-down procedure of the present invention for a fuel cell. The shut-down procedure of the present invention for a fuel cell is used in a fuel cell 100, for closing the working state of the fuel cell 100 in which electricity is generated. The fuel cell 100 includes a control unit 110, a portion of electricity generation 120, an outer load terminal 150, an inner load terminal 160, a fuel tank body 170, a pump 130 and a fan 140, wherein the control unit 110 is a micro-controller, for providing logic control to the fuel cell; the portion of electricity generation 120 is an energy converting apparatus having an anode 122, a proton exchange membrane 123 and a cathode 124, for converting input fuel into output electricity; the inner load terminal 160 has means of transmitting electricity, electrically connected to those electricity consuming elements such as the control unit 110, the pump 130 and the fan 140 of the fuel cell 100, for providing the electricity necessary to the work of the control unit 110, the pump 130 and the fan 140; and the outer load terminal 150 has means of transmitting electricity, electrically connected to any outer electric elements (not shown) outside of the fuel cell 100, for providing the electricity necessary to the work of the outer electric elements.

For the elements described above, fuel solution provided for the electrochemical reaction in the proton exchange membrane 123 is contained within the fuel tank body 170 and is conducted to the anode 122 and the cathode 124. Between the electrodes is constructed the permeable proton exchange membrane 123 whose surface is coated with a catalyst to increase the reaction rate. The principal part of the electrolyte forms as an ion exchange membrane. The fuel solution within the fuel tank body 170 is drawn by the pump 130 to enter the anode 122 of the portion of electricity generation 120 while oxygen from the air enters the cathode 124, so that the portion of electricity generation 120 can perform electrochemical reaction to generate electricity through the proton exchange membrane 123. In the electrochemical reaction, the hydrogen atoms of the fuel solution in the proton exchange membrane 123 crack into protons and electrons by the catalysis of the proton exchange membrane 123, wherein the protons are attracted by oxygen to the other side of the proton exchange membrane 123 while the electrons flow via the outer load terminal 150, forming electrical current, and reach the cathode 124 to react with the oxygen ions, which are to be reduced, to form water. When there are no loads at the two ends of the outer load terminal 150 between the anode 122 and the cathode 124, the control unit 110 makes a shut-down instruction on detecting this situation and the pump 130 stops working accordingly, wherein the pump 130 functions to draw the fuel solution from the fuel tank body 170 to the anode 122 and, when stopping, provides no fuel for the electrochemical reaction. On the other hand, the fan 140 functions to dissipate the heat produced in the electrochemical reaction and to provide sufficient oxygen to the cathode 124.

The fuel cell 100 further includes a temperature sensor 190 used for measuring the temperatures inside and outside the fuel cell 100. Refer to FIG. 1 again. The heat produced inside the fuel cell 100 due to the work of those elements is denoted as an inner heat source 190a and the heat produced by the environment is denoted as an outer heat source 190b. The temperature sensor 190 may feed back the temperatures to the control unit 110 when the inner heat source 190a and the outer heat source 190b act on the temperature sensor 190, so that the control unit 110 may acquire the temperature difference between the inside and the outside of the fuel cell 100 and judge whether the shut-down procedure should end or not according to the temperature difference and whether the fan 140 should stop or not.

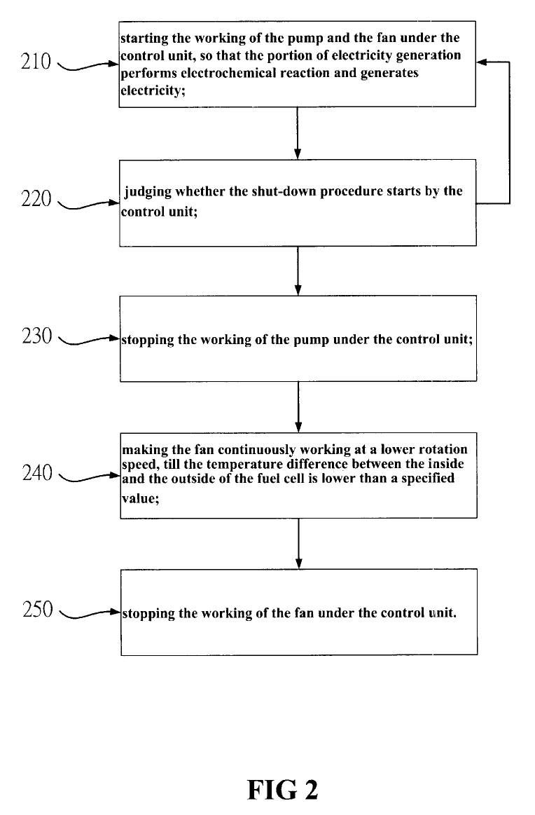

Refer to FIGS. 1 and 2, of which FIG. 2 is a flow chart of the shut-down procedure of the present invention for a fuel cell. An embodiment of the shut-down procedure of the present invention for a fuel cell comprises: step 210 of controlling the work of the pump 130 and the fan 140 under the control unit 110, to supply the fuel necessary to the anode 122 and the cathode 124 of the portion of electricity generation 120, respectively so that the proton exchange membrane 123 of the portion of electricity generation 120 may perform an electrochemical reaction and generate electricity; step 220 of judging whether the shut-down procedure starts or not by the control unit 110, wherein the control unit 110 goes to step 210 if the shut-down procedure does not start as selected whereas the control unit 110 goes to step 230 if the shut-down procedure starts as selected; step 230 of stopping the work of the pump under the control of the control unit 110, wherein no further fuel is supplied to the anode 122 of the portion of electricity generation 120 so that only the fuel solution residue is used; step 240 of making the fan 140 continuously working at a lower rotation speed, feeding back, by the temperature sensor 190, the temperatures inside and outside the fuel cell 100 to the control unit 110, judging, by the control unit 110, whether the temperature difference between the inside and the outside of the fuel cell 100 is lower than a specified value of temperature difference or not, and going to step 250 if the temperature difference between the inside and the outside of the fuel cell 100 is judged to be lower than the specified value; and step 250 of stopping the work of the fan 140 under the control of the control unit 110.

Thus, the concentration of the fuel solution residue in the anode 122 of the portion of electricity generation 120 may be lower than a specified value of concentration so as to avoid or decrease damage in the proton exchange membrane 123 of the portion of electricity generation 120. Also, in the electrochemical reaction of the fuel solution residue, continuously working of the fan 140 can lower the temperature of the portion of electricity generation 120 and drain the mist in the portion of electricity generation 120 to avoid condensation of mist that would result in short circuit among the sets of membrane electrodes.

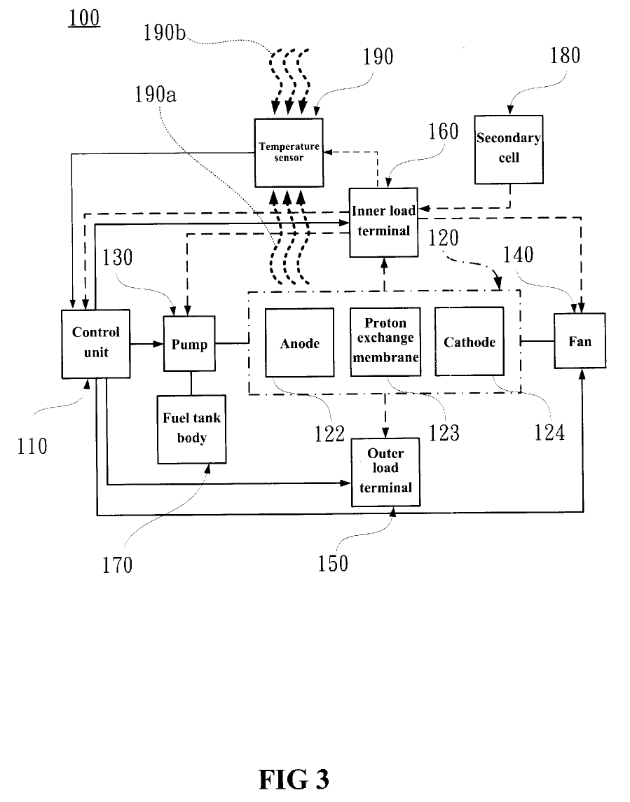

Refer to FIG. 3, which illustrates a diagram of element relation for the shut-down procedure of the present invention for a fuel cell. A secondary cell 180 is further added to the fuel cell 100 to the previous embodiment. The secondary cell 180 is an energy carrier being capable of outputting electricity and charging electricity and the secondary cell 180 is electrically connected to the inner load terminal 160. When the output electricity of the fuel cell 100 is insufficient, the secondary cell 180 may be used as an auxiliary supply, for providing electricity, through the inner load terminal 160, to those electricity consuming elements such as the control unit 110, the pump 130 and the fan 140 of the fuel cell 100.

The secondary cell 180 as described above may be the lithium cell, the nickel mental hydride cell, the nickel cadmium cell or other rechargeable cells.

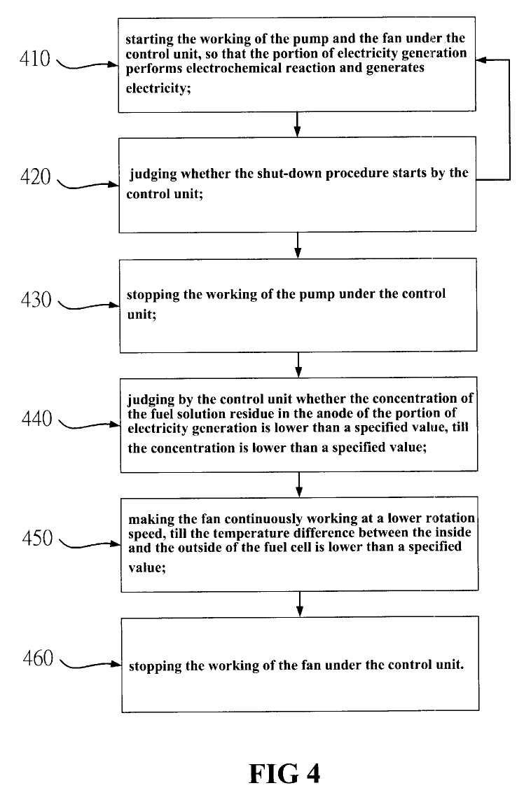

Refer to FIGS. 3 and 4, of which FIG. 4 is a flow chart of the shut-down procedure of the present invention for a fuel cell based on the embodiment in FIG. 3. Based on the embodiment, the shut-down procedure comprises: step 410 of controlling the work of the pump 130 and the fan 140 under the control unit 110, to supply the fuel necessary to the anode 122 and the cathode 124 of the portion of electricity generation 120, respectively so that the proton exchange membrane 123 of the portion of electricity generation 120 may perform an electrochemical reaction and generate electricity; step 420 of judging whether the shut-down procedure starts or not by the control unit 110, wherein the control unit 110 goes to step 410 if the shut-down procedure does not start as selected whereas the control unit 110 goes to step 430 if the shut-down procedure starts as selected; step 430 of stopping the work of the pump 130 under the control of the control unit 110, wherein no further fuel is supplied to the anode 122 of the portion of electricity generation 120 so that only the fuel solution residue is used; step 440 of judging, by the control unit 110, whether the concentration of the fuel solution residue in anode 122 of the portion of electricity generation 120 is lower than a specified value of concentration and going to step 450 if the concentration of the fuel solution residue is judged to be lower than the specified value; step 450 of providing electricity from the secondary cell 180, through the inner load terminal 160, to the control unit 110, the pump 130 and the fan 140 of the fuel cell 100, making the fan 140 continuously working at a lower rotation speed, feeding back, by the temperature sensor 190, the temperatures inside and outside the fuel cell 100 to the control unit 110, judging, by the control unit 110, whether the temperature difference between the inside and the outside of the fuel cell 100 is lower than a specified value of temperature difference or not, and going to step 460 if the temperature difference between the inside and the outside of the fuel cell 100 is judged to be lower than the specified value; and step 460 of stopping the work of the fan 140 under the control of the control unit 110.

The step of judging, by the control unit 110, whether the concentration of the fuel solution residue in the anode 122 of the portion of electricity generation 120 is lower than a specified value of concentration may be replaced by a step of judging whether the output voltage of the portion of electricity generation 120 is lower than a specified value of voltage.

Besides, in the shut-down procedure of the present invention for a fuel cell, the concentration of the fuel solution residue may be determined by judging the output power of the portion of electricity generation 120.

Furthermore, the temperature sensor 190 described above may be formed of any temperature-sensing device selected from the group consisting of thermal resistor and thermocouple, so that it may be used for measuring the temperatures inside and outside the fuel cell 100.

Although the invention has been described by way of examples and in terms of preferred embodiments, it is to be understood that the invention is not limited thereto. Various modifications and variations may be made by those skilled in this art without departing the spirit and scope of the present invention. The scope of the appended claims should encompass all such variations and modifications.

What is claimed is:

1. A shut-down procedure for a fuel cell, which includes a portion of electricity generation, a control unit, an inner load terminal, an outer load terminal, a fan, a pump and means of judging temperature difference for judging whether the temperature difference between the inside and the outside of the fuel cell is lower than a specified value of temperature difference or not, and works with the fan and the pump working continuously under the control of the control unit, the shut-down procedure starting under the judgment of the control unit and comprising steps of:
starting as selected by the control unit, together with stopping the working of the pump as selected by the control unit;
judging whether the temperature difference between the inside and the outside of the fuel cell is lower than a specified value of temperature difference or not, by the means of judging temperature difference; and
stopping the working of the fan as selected by the control unit if the temperature difference between the inside and the outside of the fuel cell is lower than the specified value of temperature difference.

2. The shut-down procedure for a fuel cell as claimed in claim 1, wherein the means of judging temperature difference comprises the control unit and a temperature sensor for sensing the temperatures inside and outside the fuel cell and feeding back the temperatures to the control unit to judge whether the temperature difference between the inside and the outside of the fuel cell is lower than the specified value of temperature difference or not.

3. The shut-down procedure for a fuel cell as claimed in claim 2, wherein the specified value of temperature difference is one sufficient to avoid condensation of mist inside the fuel cell.

4. The shut-down procedure for a fuel cell as claimed in claim 2, wherein the temperature sensor is selected from the group consisting of thermal resistor and thermocouple.

5. The shut-down procedure for a fuel cell as claimed in claim 1, wherein the fuel cell further comprises a secondary cell, which is an energy carrier being capable of outputting electricity and charging electricity and can transmit electricity to the inner load terminal.

6. The shut-down procedure for a fuel cell as claimed in claim 5, wherein the secondary cell is any rechargeable cell selected from the group consisting of lithium cell, nickel mental hydride cell and nickel cadmium cell.

7. The shut-down procedure for a fuel cell as claimed in claim 2, wherein the fuel cell further comprises means of judging concentration for judging whether the concentration of the fuel solution residue in the portion of electricity generation is lower than a specified value of concentration or not.

8. The shut-down procedure for a fuel cell as claimed in claim 7, wherein the step of starting as selected by the control unit is followed by steps of:
judging whether the concentration of the fuel solution residue in the portion of electricity generation is lower than the specified value of concentration or not, by the means of judging concentration; and
stopping the working of the fan under the control of the control unit if the concentration of the fuel solution residue in the portion of electricity generation is lower than the specified value of concentration while the temperature difference between the inside and the outside of the fuel cell is lower than the specified value of temperature difference.

9. The shut-down procedure for a fuel cell as claimed in claim 8, wherein the means of judging concentration comprises the control unit, the control unit having means of detecting voltage for judging whether the output voltage of the portion of electricity generation is lower than a specified value of voltage so that the concentration of the fuel solution residue in the portion of electricity generation is judged to be lower than the specified value of concentration if the output voltage of the portion of electricity generation is lower than the specified value of voltage.

10. The shut-down procedure for a fuel cell as claimed in claim 9, wherein the means of judging temperature difference comprises the control unit and a temperature sensor for sensing the temperatures inside and outside the fuel cell and feeding back the temperatures to the control unit to judge whether the temperature difference between the inside and the outside of the fuel cell is lower than the specified value of temperature difference or not.

11. The shut-down procedure for a fuel cell as claimed in claim 8, wherein the concentration of the fuel solution residue may be determined by judging the output power of the portion of electricity generation.

12. The shut-down procedure for a fuel cell as claimed in claim 8, wherein the temperature sensor is selected from the group consisting of thermal resistor and thermocouple.
